(19) United States
(12) Patent Application Publication
(10) Pub. No.: US 2002/0123368 A1
(43) Pub. Date: Sep. 5, 2002

(54) Pocket telephone

(76) Inventors: Hitoshi Yamadera, Tokyo (JP); Satoko Kojima, Kokubunji (JP); Kazumi Matsumoto, Kokubunji (JP); Minoru Ikeda, Inagi (JP); Kaori Kashimura, Tokyo (JP); Tsutomu Hatakeyama, Tachikawa (JP); Takafumi Kawasaki, Sagamihara (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 09/932,112

(22) Filed: Aug. 20, 2001

(30) Foreign Application Priority Data
Mar. 2, 2001 (JP) 13-058510

(51) Int. Cl. H04M 1/00

(52) U.S. Cl. 455/556; 455/550

(57) ABSTRACT

The focus is positioned on one of the icons shown on a main menu screen and the focal icon is shown enlarged, while the remaining icons are visible.

On the main menu screen 40, as shown in FIG. 6(b), a plurality of icons 41 corresponding to items or groups of items from which to choose are shown. The focus (selector) is positioned on one of the icons (the focal icon is surrounded by a frame-like cursor 42) and the focal icon is shown enlarged. By working the joy stick (not shown), the user can shift the focus to any icon. The remaining icons 41 other than the focus icon 41 shift to be more closely spaced, thus widening the area where the focal icon is shown. No matter what icon 41 is chosen as the focal one, the icons 4 shown remain the same.

### FIELD OF THE INVENTION

The present invention relates to a pocket telephone enabling its user to perform communications by telephony and E-mail by working the function keys and character input keys on its operation surface, based on the information contents shown on its display screen.

### BACKGROUND OF THE INVENTION

Pocket telephones are becoming very convenient tools provided with diverse functions such as mailing and communications over the Internet in addition to wireless telephony.

Such a pocket telephone has a display screen and operation surface on which function keys and character input keys are arranged. By using these character input keys, its user can enter a telephone number when making a call or characters of mail text when sending mail.

The pocket telephone is provided with various kinds of functions and user options such as date/time display, alarm, ringer volume, ringer tone pattern, wall paper background of a standby screen and enables the user to set or customize these functions and user options and make sure of the settings. Setting or customizing these functions and user options and making sure of the settings can be performed by working the function keys on the operation surface, based on the menu screen, selecting function screens, and other screens displayed on the display screen.

For predecessor pocket telephones, a plurality of letters, numeric-characters and/or symbols are assigned to one character input key because of the limited number of character input keys (dial keys) arranged on the operation surface. Three or more alphabet letters are assigned to the character input keys in alphabetical order; e.g., three alphabet letters “A”, “B”, and “C” are assigned to a first character input key and three alphabet letters “D”, “E”, and “F” are assigned to a second character input key, and so on.

In this manner of assigning the alphabet letters to the keys, the arrangement of most frequently used character input keys to which “A”, “I”, “U”, “E”, and “O” are assigned is unsystematic. These alphabet letters correspond to the vowels in Japanese and are most frequently used when entering characters by means of Romaji (alphabetical notation of Japanese). This poses a problem that the user has to move the thumb or other fingers or its equivalent here and there when entering characters to be mailed or for other purposes, that is, the key arrangement is not user-friendly.

For predecessor pocket telephones, the standby screen is displayed as the initial screen when the telephone is powered on. In this display state, by actuating a specific function key on the operation surface, then the main menu screen is chosen and opened. The standby screen is switched to the main menu screen on which a further screen (a selecting function screen) is to be chosen for setting any function or user option of the pocket telephone and making sure of the setting. After being opened, this main menu screen is not related to the preceding screen (in this case, the standby screen). If the main menu screen remains open for long time, the user may be uncertain of what screen from which the main menu screen was opened (that is, what is the preceding screen). When performing some further operation that requires reverting from the currently displayed screen, the user may be at loss for what to do next because of being uncertain of the back way situation. This possibility is not limited to the main menu screen.

For predecessor pocket telephones, moreover, a plurality of icons for items from which to choose is shown, arranged in an array on the main menu screen. By working the joy stick on the operation surface, the user positions the focus on one of these icons (in other words, an item to choose) and chooses it by fixing action. In cases where many icons are shown simultaneously on the main menu screen, the icons are shown so small that the user cannot identify them.

As one solution to this problem, it is possible to enlarge the focal icon. However, the area of the enlarged icon may conceal the area where other icons are shown from view and some icons may become invisible. Consequently, to seek another icon, you have to set the focus off once and additional operation is required.

Furthermore, predecessor pocket telephones are provided with an address book function for registering names of persons or parties whom the user of the pocket telephone has contacted or may contact and displaying the entries are displayed in a list. The user may want to obtain more information than the name and telephone number of one of these entries. To meet such request, it is possible that the detailed information of an entry is shown on the address book screen. When the user positions the focus on one of the entries to obtain its detailed information and fixes it, the area where the detail information is presented is enlarged. However, this area may conceal other entries displayed on the address screen or expel them out of the screen. If part of the displayed entries become invisible, the user may feel bad. To view the detail of the entries one by one in the listed order, the user has to set the focus off once again.

Moreover, the user of the pocket telephone may want to check the record of a person or party whom he or she has contacted. For example, the user may want to make certain that he or she contacted a person or party by telephony, E-mail, or C-mail. For meeting such request, the pocket telephone reads the number entry of the parson or party and displays it on the screen. However, the user must judge that it is telephony, E-mail, or C-mail from the displayed number, which may seem troublesome to the user.

In response to creating mail to send, a create new mail screen or the like is displayed, allowing the user to enter mail text. The create mail screen comprises the input fields for address of mail destination, subject, mail text, etc. into which the user enters character strings by using the character input keys. In cases that the user is uncertain of how to do, the user can call help. For predecessor pocket telephones, to obtain help information, the user must choose the help icon shown in a specific position on the create new mail screen. However, the help display contains all matters about the create new mail screen, from which the user must seek necessary help information (for example, how to input the address of mail destination), which may seem troublesome to the user.

Pocket telephone supplying companies supply diverse models of pocket telephones, whose specifications differ, depending on the companies. Because users select a pocket telephone model to their taste, different users use different pocket telephone models. Consequently, the user of a pocket telephone model may create mail over the maximum number of characters displayable that is specified for a different model and send the mail to the user of the different model. In this case, the pocket telephone of the mail recipient displays only the part of the mail falling within the maximum range on its display and in most cases the sender is not aware of this fact. This may hinder the mail sender and recipient from coming to adequate mutual understanding.

For predecessor pocket telephones, furthermore, by choosing a specific icon on the main menu screen, the selecting function screen of the item of the icon is opened and this screen does not has relation to the main menu screen. If the user wants to choose another selecting function screen, the user must return to the main menu screen, which also poses an operability problem that screen switch is not smooth.

### SUMMARY OF THE INVENTION

A first object of the present invention is to provide a pocket telephone that enables its user to operate it more easily by allowing for smoother finger moving when the user enters characters with the keys, thereby settling the above-mentioned problems.

A second object of the present invention is to provide a pocket telephone that enables its user to make ascertain of the preceding screen just before the currently displayed screen and thus enables smoother operation, thereby settling the above-mentioned problems.

A third object of the present invention is to provide a pocket telephone that enables an enlarged view of the focal icon with all remaining icons remaining visible, thereby settling the above-mentioned problems.

A fourth object of the present invention is to provide a pocket telephone that maintains the number of entries of persons or parties whom its user has contacted or may contact to be displayed on the address book screen, while enabling the user to make sure of the detailed information for one of the entries, thereby settling the above-mentioned problems.

A fifth object of the present invention is to provide a pocket telephone that enables its user to easily know the type of contact means for each person or party whom the user has contacted or may contact, thereby settling the above-mentioned problems.

A sixth object of the present invention is to provide a pocket telephone that enables its user to obtain required help information surely and easily, thereby settling the above-mentioned problems.

A seventh object of the present invention is to provide a pocket telephone that enables its user to communicate with the other party or person in a mode compatible with the functionality of the pocket telephone model or other communications equipment used by the other party or person, thereby settling the above-mentioned problems.

An eighth object of the present invention is to provide a pocket telephone that enables simple user operation in choosing another selecting function screen when a selecting function screen being opened after chosen on the main menu screen, thereby settling the above-mentioned problems.

To achieve the foregoing first object, the present invention provides a pocket telephone including an operation surface on which function keys and character input keys arrayed in three columns by four rows are provided, the character input keys comprising three columns of keys, one of which consisting of four character input keys to which four out of five alphabet letters corresponding to the vowels in Japanese are assigned to be used to enter Japanese characters in Romaji input mode, the remaining one of the five alphabet letters being assigned to a function key just above the top character input key in the same column, wherein the keys of the five alphabet letters are arranged in the order of the vowels according to the Japanese syllabary.

To achieve the foregoing second object, the present invention provides a pocket telephone arranged such that a standby screen is displayed when its power is turned on and a predetermined screen is opened by actuating a function key on the operation surface, wherein the predetermined screen is superposed on the standby screen so that the standby screen will be visible through the predetermined screen.

The pocket telephone is also arrange such that a selecting function screen is opened by choosing one of the icons of the items or groups of items from which to choose displayed on the main menu screen, and on the selecting function screen, the chosen icon as well as particular items under the thus chosen item are displayed.

To achieve the foregoing third object, the present invention provides a pocket telephone arranged such that, on the main menu screen, a plurality of icons are shown, arranged in an array, corresponding to items or groups of items from which to choose, one of the icons on which the focus is positioned is shown enlarged, and the remaining icons other than the focal icon shift, thus providing space for widening the area where the focal icon is shown. In this case, further arrangement can be made such that the remaining icons other than the focal icon shift with their size being downscaled, thus providing more space for widening the area where the focal icon is shown.

To achieve the foregoing fourth object, the present invention provides a pocket telephone arranged such that an address book screen can be opened on which a plurality of name entries of persons or parties whom the pocket telephone user has contacted or may contact are displayed in a list, wherein the focus is always positioned on one of the entries, for the focal entry, its detailed information about the address book as well as the name of the person or party being displayed.

To achieve the foregoing fifth object, the present invention provides a pocket telephone arranged such that a record screen can be opened on which a plurality of name entries of persons or parties whom the pocket telephone user has contacted are displayed in a list, wherein an icon to indicate the type of contact means taken at the last contact is attached to each name entry and the focus is positioned on one of the entries, for the focal entry, its record information such as last contact date/time, the number of times of contacts, etc. as well as the name of the person or party being displayed.

To achieve the foregoing sixth object, the present invention provides a pocket telephone arranged such that a create mail screen comprising a plurality of input fields can be opened, wherein a help icon is assigned to each of the input fields so that the pocket telephone user can obtain help information for each input field.

To achieve the foregoing seventh object, the present invention provides a pocket telephone arranged such that, for persons or parties whom the pocket telephone user has contacted or may contact, functional information about their pocket telephone model or other communications equipment, such as the maximum number of characters displayable, displayable file formats, etc. is stored in memory so that the user can refer to the functional information when entering mail text at the create main screen.

The pocket telephone is also arranged such that a letter type select screen can be opened on which a plurality of icons of letter type options are laid out, on one of which the focus is always positioned, by actuating a specific key on the operation surface and choosing from a submenu when the create new mail screen is displayed.

To achieve the foregoing eighth object, the present invention provides a pocket telephone arranged such that, on the main menu screen, a plurality of icons are shown, arranged in a single row, corresponding to items or groups of items from which to choose, with one of the plurality of icons being selected by default and the focus being positioned on it, wherein the pocket telephone user can choose any desired icon by shifting the focus. By choosing to fix the focal icon, a selecting function screen is opened on which particular items under the item of the chosen icon are displayed in a list with the icons in the row remaining visible.

### BRIEF DESCRIPTION OF THE DRAWINGS

FIG. 1 is a front view of a pocket telephone that is a preferred embodiment of the present invention.

FIG. 2 is an illustration depicting an exemplary arrangement of the dial keys of the pocket telephone shown in FIG. 1.

FIG. 3 is a block diagram representing the hardware configuration of the pocket telephone shown in FIG. 1.

FIG. 4 is a diagram representing hierarchical organization of most screens to be displayed or opened on the pocket telephone shown in FIG. 1, including illustrative user operation for opening a specific screen.

FIG. 5 shows examples of a standby screen mentioned in FIG. 4.

FIG. 6 shows examples of the main menu screen opened by being chosen on the standby screen exemplified in FIG. 5.

FIG. 7 lists examples of items from which to choose whose icons are shown on the main menu screen exemplified in FIG. 6 and examples of function items to be displayed on a selecting function screen.

FIG. 8 shows a selecting function screen example chosen from the main menu screen exemplified in FIG. 6.

FIG. 9 shows another selecting function screen example chosen from the main menu screen exemplified in FIG. 6.

FIG. 10 shows examples of a setting item confirming screen chosen by user operation from the main menu screen exemplified in FIG. 6.

FIG. 11 shows an example of a setting item changing screen chosen by user operation from the main menu screen exemplified in FIG. 6.

FIG. 12 shows an example of an address book screen opened by being chosen on the standby screen exemplified in FIG. 5.

FIG. 13 shows an example of a redial/incoming call record screen opened by being chosen on the standby screen exemplified in FIG. 5.

FIG. 14 shows examples of a create new mail screen opened from the standby screen exemplified in FIG. 5.

FIG. 15 shows examples of a letter type select screen as a submenu screen under the create new mail screen exemplified in FIG. 14.

FIG. 16 shows examples of another version of the main menu screen chosen from the standby screen exemplified in FIG. 15.

FIG. 17 shows yet another example of another version of the main menu screen chosen from the standby screen exemplified in FIG. 15.

### DETAILED DESCRIPTION OF THE PREFERRED EMBODIMENTS OF THE INVENTION

A preferred embodiment of the present invention will now be described with reference to the appended drawings.

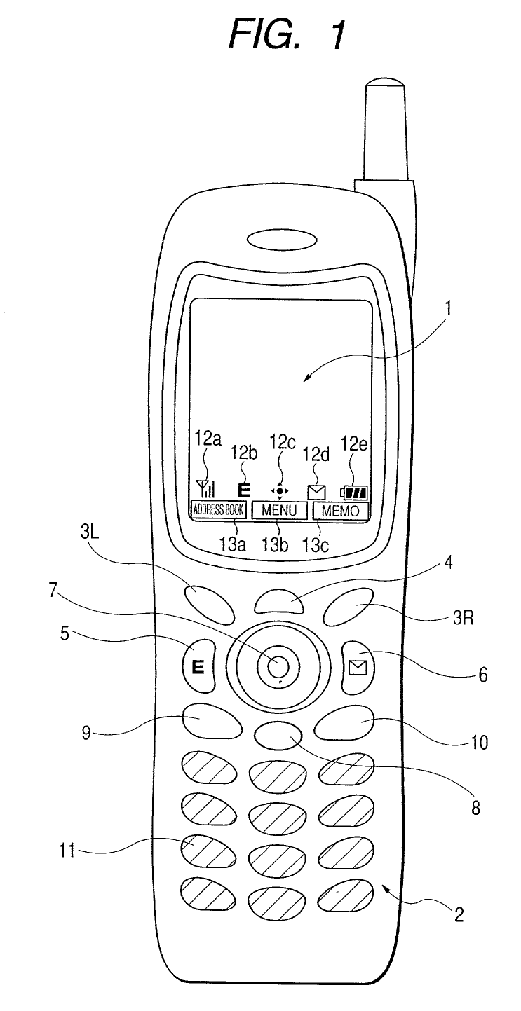

FIG. 1 is a front view of a pocket telephone that is a preferred embodiment of the present invention. Reference numeral 1 denotes a display screen; 2 denotes an operation surface; 3L denotes a left software key; 3R denotes a right software key; 4 denotes a direct key; 5 denotes a web key; 6 denotes a mail key; 7 denotes a joy stick; 8 denotes a clear key; 9 denotes a call key; 10 denotes an end key; 11 denotes dial keys (a total of 12 keys hatched); 12a denotes a reception intensity icon; 12b denotes a web icon; 12c denotes a joy stick icon; 12d denotes a mail icon; 12e denotes a battery icon; and 13a to 13c denote function display boxes.

As shown in FIG. 1, the front surface of the telephone body is roughly separated into upper and lower halves: there are the display screen 1 in the upper half and the operation surface 2 in the lower half.

On the operation surface 2, operation keys are arranged in three columns. In the top row, the left software key 3L, direct key 4, and right software key 3R are lined from the left to right. The functions of the left software key 3L and right software key 3R change, according to what is displayed on the display screen 1, and correspond to the function display boxes 13a and 13b shown on the bottom line on the display screen 1. In the case shown in FIG. 1, the left software key 3L has a function of bringing up an address book on the screen as is indicated in the function display box 13a and the right software key 3R has a function of making the pocket telephone execute a memo function as is indicated in the function display box 13c.

In the second row, the web key 5, joy stick 7, and mail key 6 are lined from the left to right. Icons corresponding to these keys are shown in line above the bottom line of the function display boxes 13a to 13c to indicate the operating state of the pocket telephone. On the illustrative icons arrayed here, the joy stick icon 12c is shown in the middle with the web icon 12b being shown on its left side and the mail icon 12d being shown on its right side, corresponding to the positions of the joy stick 7, web key 5 and mail key 6. When the user presses the web key 6 to get a web service over the Internet, the web icon 12b appears to tell the user that the telephone executes the procedure for getting the web service. When the pocket telephone receives mail, the mail icon 12d appears. The mail key 6 is used to open the received mail or send mail and the mail icon 12d remains visible until the received mail has been opened. The joy stick 7 can be thrown up and down and to the right and left and pressed. The joy stick icon 12c tells the user that the joy stick 7 is workable in this way while it remains visible. A function that is to be activated by pressing the joy stick 7 is displayed in the function display box 13b. The display of the pocket telephone shown in FIG. 1 indicates that the joy stick 7 is workable (the joy stick icon 12c is visible) and a menu screen will be displayed when you work the joy stick (as indicated by “MENU” which is shown in the function display box 13b).

As described above, the pocket telephone's display screen has been devised such that the function display boxes 13a and 13b corresponding to the functions of the left software key 3L and right software key 3R are shown at the bottom of the display screen 1 and the icons 12b, 12c, and 12d corresponding to the web key 5, joy stick 7 and mail key 6 are also shown in the same positions as in the row of the keys just above the line of the function display boxes 13a to 13c on the display screen 1. In short, the icons and indexes indicating the functions or states of the function keys are displayed in place corresponding to the positions of the function keys. Because of these distinct correspondences between the function keys and those shown on the display screen 1, it will become very easy for the user to work the function keys.

Moreover, on the display screen 1, the reception intensity icon 12a is shown on the left side of the web icon 12 to indicate the intensity of the electric field of radio waves received by the pocket telephone in the current position. On the left side of the web icon 12b, the battery icon 12e is shown to indicate the battery charge state. Displaying the reception intensity icon 12a and battery icon 12e may be predetermined such that the appropriate icon appears only when the intensity of the electric field of received radio waves becomes very low or when the battery comes to contain only a small amount of charge.

In the next row under the row with the web key 5 in the first column place, there are the call key 9 to be pressed to make a call, the clear key 8 to be used to make the screen displayed on the display screen 1 revert to the preceding one or delete one character entered at the last or a target character, and the end key 10 to be pressed to disconnect the call.

Under the row with the call key 9 in the first column place, there are dial keys 11 (hatched keys) arranged in three columns by four rows which are used as input keys for entering a telephone number, text, etc.

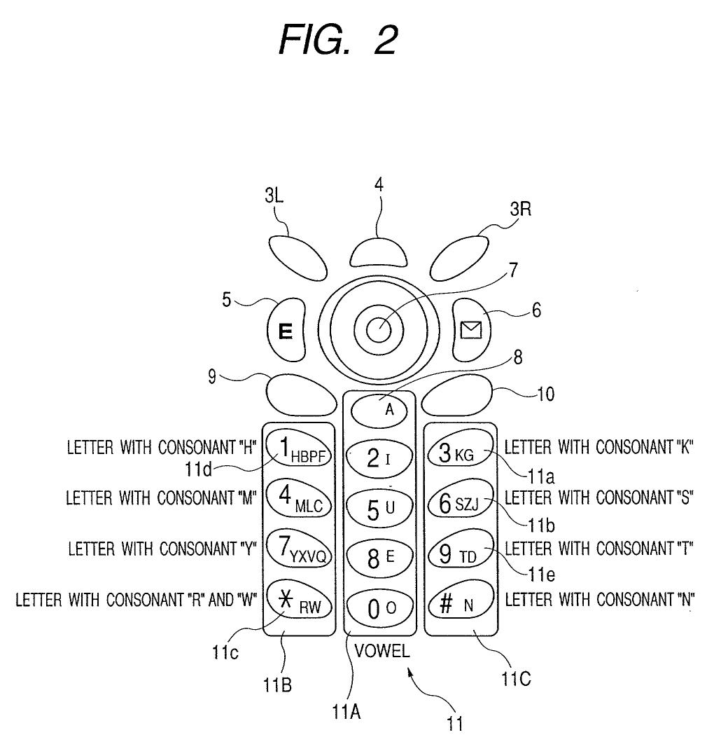

FIG. 2 is an illustration depicting an exemplary arrangement of these dial keys 11, wherein the operation keys corresponding to those shown in FIG. 1 are assigned the same reference numbers and their explanation will not be repeated.

The dial keys arrayed in three columns by four rows, shown in FIG. 2, are the same as those of previous pocket telephones in respect of the input keys for entering numbers and symbols. For their use to enter characters, these dial keys 11 will be referred to as character input keys. For this use, the character input function is also assigned to the clear key 8. The keys are arranged in three blocks: five character input keys including the clear key 8 vertically aligned in the middle column 11A, four character input keys vertically aligned in the left column 11B, and four character input keys vertically aligned in the right column 11C.

To the input character keys in the middle column 11A, respectively in order from top to down, alphabets A, I, U, E, and O are assigned, as shown, which correspond to the vowels in Japanese. If, for example, the clear key 8 is pressed, character “A” will be entered. When one of the above alphabets is entered by using the corresponding character input key in the column 11A, the entered alphabet is fixed. Numerals “2”, “5”, “8”, and “0” are also assigned to these character input keys except the clear key, respectively. Using these keys, if a number is entered, but unfixed and an alphabet is entered immediately following that, the entered alphabet will be fixed.

When the clear key 8 is used as one of the character input keys, its clear function is disabled. Once you have entered a character on a screen prompting the user to fill the fields of a form with characters, the left software key 3L functions as a clear key with “CLEAR” being displayed in the function display box 13a (FIG. 1).

To the character input keys in the column 11C, respectively in order from top to down, consonantal letters “K”, “S”, “T”, and “N” and other letters as their voiced consonants if exist and for making p-sounds or contracted sounds if exist are assigned, as shown. For example, to a character input key 11a, alphabet letters “K” and “G” are assigned in addition to numeral “3”. By using this character input key 11a in combination with the keys in the column 11A, kanas “Ka, Ki, Ku, Ke, Ko” beginning with the “K” consonant and kanas “Ga, Gi, Gu, Ge, Go” beginning with the “G” voiced consonant can be entered. To a character input key 11b, alphabet letters “S”, “Z”, and “J” are assigned in addition to numeral “6”. By using this character input key 11b in combination with the keys in the column 11A, kanas “Sa, Si, Su, Se, So” beginning with the “S” consonant, kanas “Za, Zi, Zu, Ze, Zo” beginning with the “Z” voiced consonant, and kanas “Ja, Ju, Jo”, contracted sounds starting with “J”, can be entered. To enter kana “N”, type double “N” alphabet letters, using a character input key 11e to which “N” is assigned. If another consonantal letter is typed following a single “N” alphabet letter typed with the key 11e, the “N” is fixed as kana “N”.

To the upper three character input keys in the column 11B, respectively in order from top to down, consonantal letters “H”, “M”, and “Y” and other letters as their voiced consonants if exist and for making p-sounds or contracted sounds if exist are assigned, as shown. To the bottom character input key 11c in the column 11B, consonantal letters “R” and “W” and other letters as their voiced consonants if exist and for making p-sounds or contracted sounds if exist are assigned. For example, to a character input key 11d, alphabet letters “H”, “B”, “P”, and “F” are assigned in addition to numeral “1”. By using this character input key lid in combination with the keys in the column 11A, kanas “Ha, Hi, Hu, He, Ho” beginning with the “H” consonant, kanas “Ba, Bi, Bu, Be, Bo” beginning with the “B” voiced consonant, kanas “Pa, Pi, Pu, Pe, Po”, p-sounds starting with “P”, and kanas “Fa, Fi, Fe, Fo”, contracted sounds starting with “F” can be entered.

Because alphabet letters corresponding to the vowels, consonants, etc. in Japanese are systematically assigned to the character input keys as described above, kana characters of similar sound as a consonant and its voiced consonant, for example, “HaBa (meaning width)” can be entered successively by using the same input character key. It will become easy for the user to enter characters.

Text input can be performed in a commonly practiced Romaji input manner.

While the alphabets “A”, “I”, “U”, “E”, and “O” which correspond to the vowels in Japanese have been assigned to the keys in the middle key column 11A in the illustrative key arrangement described above, they may be assigned to the keys in other columns 11B and 11C and an additional function key (such as the clear key).

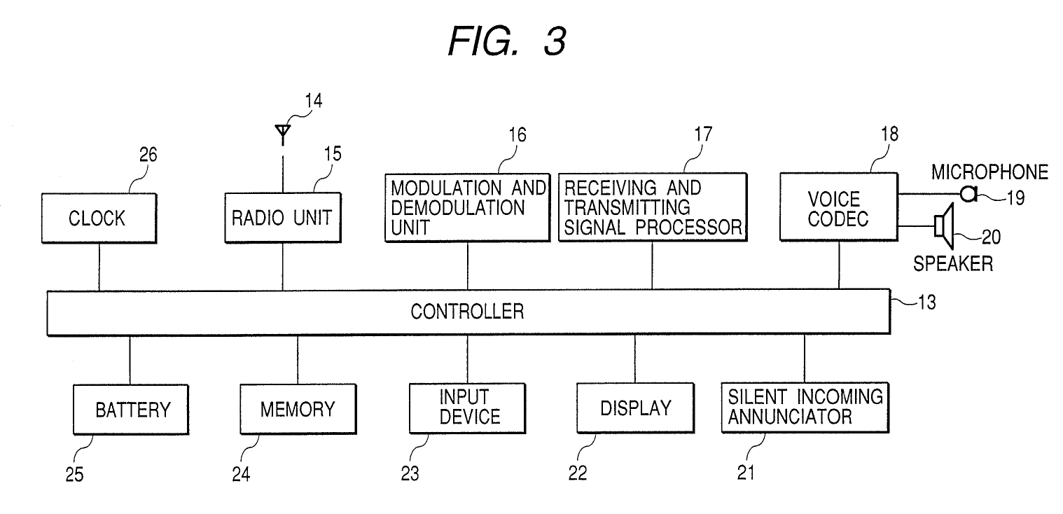

FIG. 3 is a block diagram representing the hardware configuration of the pocket telephone shown in FIG. 1.

In FIG. 3, the pocket telephone including a battery 25 for supplying power to its components carries out predetermined operation under the control of a controller 13, based on information input through an input device. The input device 23 corresponds to the set of the function and input keys on the operation surface shown in FIG. 1 and the display 22 has the display screen shown in FIG. 1.

During a call made connected by the user operation with the input device 23, voice signals input through a microphone 19 are coded by a voice CODEC (coder/decoder) 18, modulated by a modulation and demodulation unit 16, supplied to a radio unit 15, and eventually sent from an antenna 14 and transmitted over a radio channel. On the other hand, signals received at the antenna 14 are supplied via the radio unit 15 to the modulation and demodulation unit 16. After being modulated by the modulation and demodulation unit 16, the received signals are decoded into voice signals by the voice CODEC 18 and output as voice from the speaker 20. When a call arrives at the telephone from its caller, the controller 13 activates a silent incoming annunciator 21, for example, a vibrator mechanism (not shown) that works so that the user will be aware of an incoming call. Of course, an annunciator that outputs sound can be activated so that ringer tones will sound from a speaker 20.

When the user requests a web service via the Internet by using the web key 5 of the input device 23, the radio unit 15 sends the request through the antenna 14 to a predetermined server. Once the connection between the server and the pocket telephone has been established, the pocket telephone receives information requested by the user from the server. The information is demodulated by the modulation and demodulation unit 16 and stored into a memory 24, and at the same time, displayed on the display screen (FIG. 1) of the display 22. During this operation, the controller 13 keeps the web icon 12b visible on the display screen 1 of the display 22. When mail is received at the antenna 14 and through the radio unit 15, it is demodulated by the modulation and demodulation unit 16 and stored into the memory 24. At the same time, the controller 13 makes the mail icon 12d visible on the display screen 1 of the display 22. Then, the user can instruct the telephone to read the received mail from the memory 24 and display it on the display screen 1 of the display 22 by pressing the mail key 6 of the input device 23. When the user inputs mail through operating the input device 23, the mail is modulated by the modulation and demodulation unit 16 and then the radio unit 15 sends it through the antenna 14 so that it is transmitted over a radio channel.

The controller 13 acquires current date/time information from a clock 26 and makes the current date/time information displayed together with a standby screen which will be described later on the display screen 1 of the display 22. The controller 13 also keeps monitoring the remaining amount of charge in the battery 25 and makes the battery icon 12e (FIG. 1) visible on the display screen 1, which may or may not be visible, depending on the remaining amount of charge. Two-way communication between the pocket telephone and a base station, which is not shown, takes place at certain intervals, so that the base station makes sure whether the telephone stays in its coverage for supervisory purposes. During this communication, the controller 13 detects the intensity of electric field of radio signals received and makes the reception intensity icon 12a (FIG. 1) visible on the display screen 1, which may or may not be visible, depending on the result of this detection. As described above, displaying these reception intensity icon 12a and battery icon 12e may be predetermined such that the appropriate icon appears only when the intensity of the electric field of received radio waves becomes very weak or when the battery comes to contain only a small amount of charge.

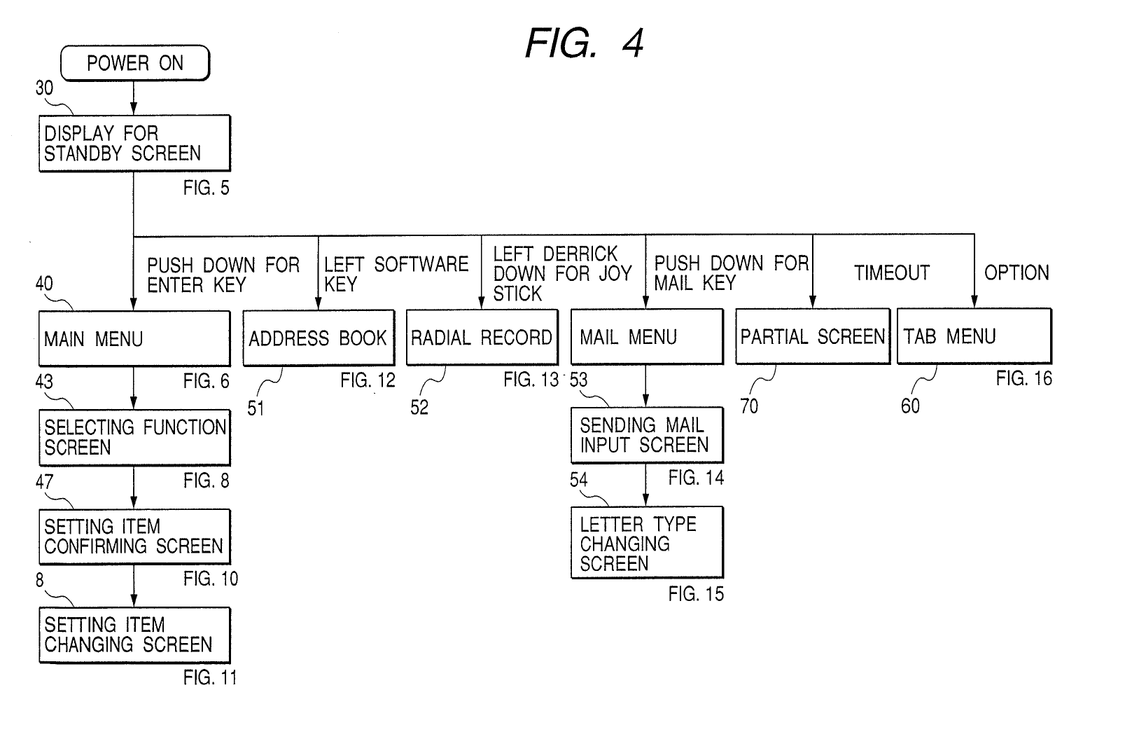

FIG. 4 is a diagram representing hierarchical organization of the screens to be displayed or opened in the present preferred embodiment, including illustrative user operation for opening a specific screen.

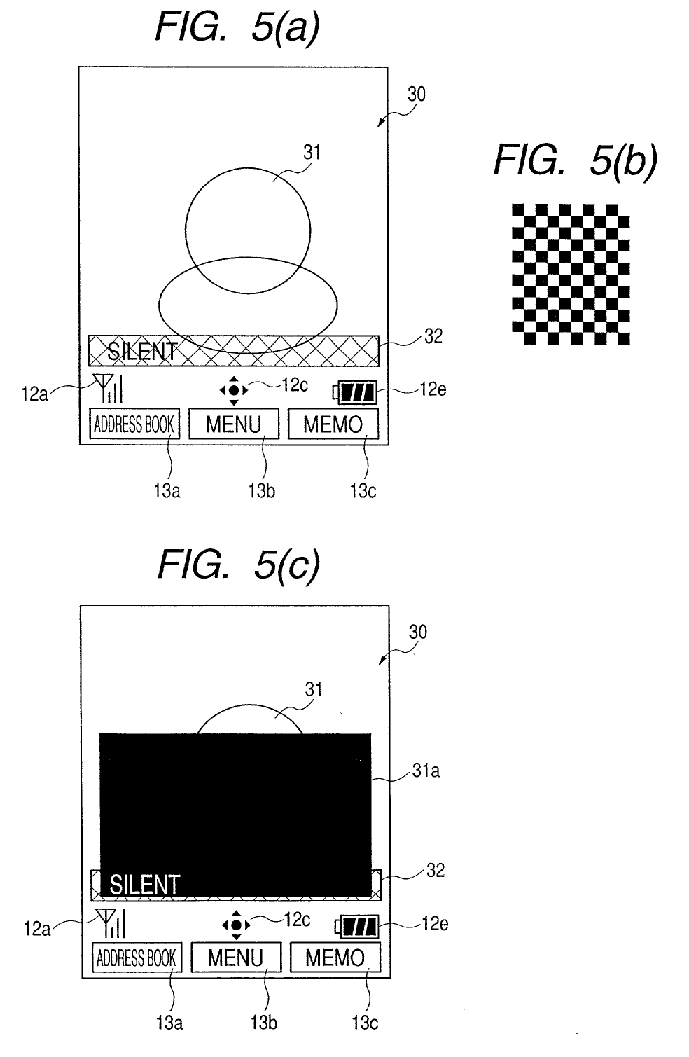

In FIG. 4, when the pocket telephone is powered on, a standby screen 30 first appears as the initial screen on the display screen 1 (FIG. 1). The standby screen 30 is a screen with a background pattern like wall paper (which will be simply referred to as wall paper, hereinafter) as is exemplified in FIGS. 5(a) and (b). At the foot of the standby screen 30, the function display boxes 13a to 13c, reception intensity icon 12a, battery icon 12e may be shown as described with FIG. 1. As will be described later, a plurality of patterns of wall paper which are diverse are prepared in this preferred embodiment. The user can select one of the patterns of wall paper as desired and change the wall paper of the standby screen 30.

If character strings offering any information about the current setup state of the pocket telephone (such as current date/time or ringer tone setting) are shown on the standby screen 30, they must be clearly and easily legible, no matter what wall paper is displayed on the background. FIG. 5 shows standby screen 30 examples where a “SILENT” string is shown, indicating a low ringer tone volume.

In view hereof, in this preferred-embodiment, if the wall paper pattern is bright (high luminance) in the display area 32 where character strings are shown, by way of example, the display area 32 will be filled with an ichimatsu pattern like a chessboard as shown in FIG. 5(b) wherein minute transparent and black squares are alternately arranged in a two-dimensional lattice so that the wall paper will be visible through the pattern. In this display area 32, character strings such as “SILENT” will be shown in black or other loud color in contrast with the wall paper. Of course, by adjusting the color and luminance of the background in the display area 32 and those of the character strings to make differentiation between both, the character strings shown in the display area 32 can be made clearly legible.

Now, assume that the luminance of characters shown in the display area 32 is Bt, mean luminance of wall paper in the display area 32 is Ba, and the maximum luminance possible on the display screen 1 (FIG. 1) and minimum luminance are Bₘₐₓ and Bₘᵢₙ. By way of example, the luminance Bt shall be set to fulfill the following constraint:

|Bt−Ba|≧(Bₘₐₓ+Bₘᵢₙ)/2

If the wall paper in the display area 32 is bright (high luminance) as shown in FIG. 5(a), the luminance difference |Bt−Ba| shall be made great enough to fulfill the above constraint; in fact, black or a dark color should be used as the color of character strings, thereby making the character strings easily distinguishable. In this case, by using the above-mentioned ichimatsu pattern as the background in the display area 32, the area where character strings are shown is made distinctive and the strings will be more easily distinguishable.

In this way, the display area where character strings are shown will be clearly recognizable for the user and the background wall paper will be visible through the pattern. Particularly, even in a case where the display area 32 is so wide as to cover the most part of the background wall paper, the background will be visible through the pattern so that the user can recognize the standby screen unconsciously.

FIG. 5(c) gives another example of the background wall paper on the standby screen including a black solid pattern 31a (low luminance) on which the display area 32 is superposed where the “SILENT” string is shown.

In this case, the black solid pattern 31a will be visible behind the see-through ichimatsu pattern in the display area 32. Consequently, the display area 32 superposed on the black solid pattern 31a is hard to see and character strings, if shown in black, are also hard to see as they are superposed on the black solid pattern 31a. In this case, it is advisable to show character strings in white as shown in FIG. 5(c). In the display area 32, at least the part of the ichimatsu pattern that is superposed on the black solid pattern 31a is not necessarily displayed. In this way, the black solid pattern 31a of the wall paper makes the character strings easily distinguishable.

Now, assume that the luminance of character strings is Bt, mean luminance of the black solid pattern 31a of wall paper in the display area 32 where the strings are shown is Bb, and the maximum luminance possible on the display screen 1 (FIG. 1) and minimum luminance are Bₘₐₓ and Bₘᵢₙ. By way of example, the luminance Bt shall be set to fulfill the following constraint:

|Bt−Bb|≧(Bₘₐₓ+Bₘᵢₙ)/2

In this way, it is advisable to adjust the luminance of character strings to be shown, according to the wall paper displayed on the standby screen 30. Furthermore, the ichimatsu pattern may or may not be shown in the display area 32 where character strings are shown. Thereby, the character strings can be shown legible; no matter what wall paper is displayed.

It is also recommendable to show the ichimatsu pattern in color in contrast with the wall paper color in the display area 32 (the black squares of the pattern shown in FIG. 5(b) should be colored).

A plurality of patterns of wall paper are stored in advance in the memory 24 (FIG. 3) of the pocket telephone, one of which can be selected for use and changed to another as will be described later. Moreover, designed screen patterns obtained by being received by mail or over the Internet can be stored as wall paper in the memory 24 and added to the wall paper options. When reading a wall paper pattern from the memory 24 for the use as the background of the standby screen 30, the controller 13 calculates the above-mentioned mean luminance Ba or Bb from the image signals of the wall paper and calculates the luminance of character strings to be shown and that of the ichimatsu pattern in the display area 32, according to the above-mentioned constraints. The controller 13 makes the character strings and display area 32 shown in accordance with the thus calculated luminance and controls whether to display the ichimatsu pattern in the display area 32.

When the standby screen 30 is displayed as exemplified in FIG. 5, the user operation with a specific key on the operation surface shown in FIG. 1 changes the screen to one of the screens belonging to the next hierarchy in FIG. 4. Information for specific operation to bring up a specific screen is also given in FIG. 4.

Screen bring-up and related operation in this preferred embodiment will be explained below. Internal control for such operation is carried out by the controller 13 (FIG. 3) with the access to the information stored in the memory 24 (FIG. 3).

[Choosing a Main Menu]

On the assumption that you choose a main menu screen 40 on the standby screen 30, the procedure of screen bring-up and related operation will be explained below.

On the standby screen 30, as exemplified in FIG. 5, “MENU” is shown in the function display box 13b corresponding to the function of the pushbutton of the joy stick 7 (FIG. 1) (by pushing down its enter button key). When you push down this enter button key, the main menu screen 40 appears on the display screen 1.

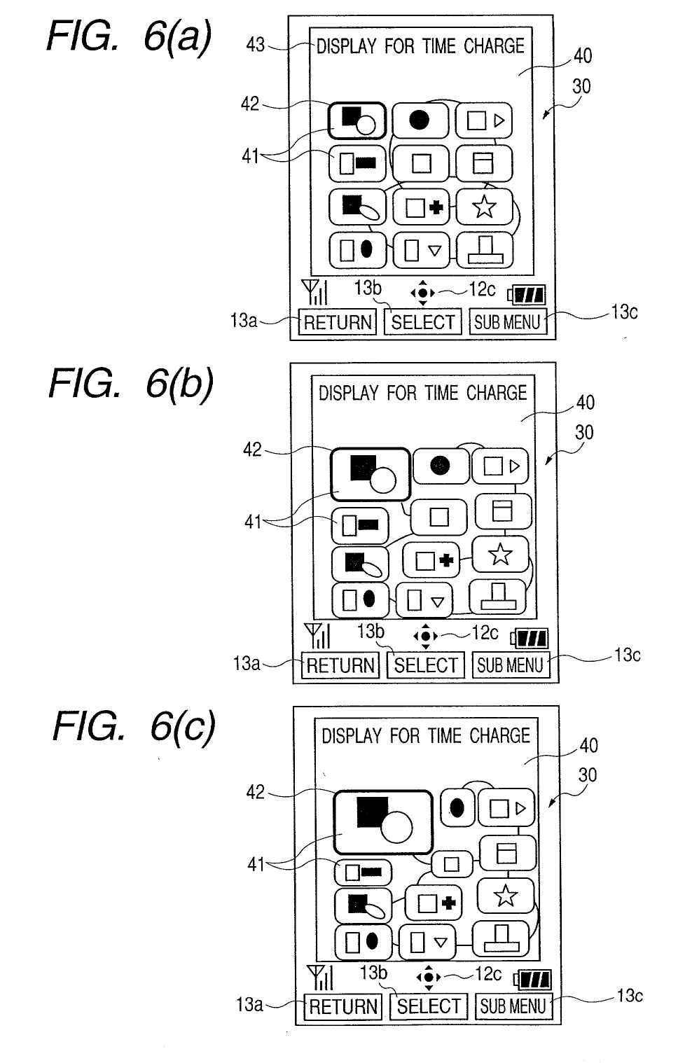

FIG. 6 shows examples of the main menu screen 40. Here, a plurality of icons 41 arranged in an array are shown, corresponding to items from which to choose; the items are selecting function screens. In the initial state of the main menu 40, one of these icons 41 is surrounded with a frame-like cursor 42 represented in a bold line, that is, one of the icons has been selected by default (on which the focus is positioned).

At the foot of the main menu screen 40, the function display boxes 13a to 13b, joy stick icon 12c and other icons are shown, indicating that the joy stick 7 (FIG. 1) is workable, what functions of the left and right software keys 3L and 3R, and what function of the enter pushbutton. As exemplified in FIG. 6, the left software key 3L has a “return” function, that is, the function of making the current screen revert to the preceding one (the standby screen 30 in this example). The function of the enter pushbutton (of the joy stick 7) is choosing (fixing) the icon 41 on which the focus is positioned when the button is pressed. The function of the right software key 3R is bringing up a submenu.

FIG. 6(a) represents the main menu screen where the focal icon 41 and other icons 41 are shown in the equal size. Even if the cursor 42 is shifted by throwing the joy stick 7 (up, down, to the left, or to the right) and the focus is shifted from the icon 41 to another icon, the state in which these icons 41 are arrayed as well as the size of the icons remain unchanged. FIG. 6(b) represents the main menu screen where the focal icon 41 is shown larger than other icons 41. The size of the focal icon 41 may be enlarged to an extent that it almost contacts with its neighboring icons 41. In the example shown in FIG. 6(b), other icons 41 are shifted a little closer each other, but do not overlap with each other as the focal icon 41 is enlarged. It is advisable to provide more space for the focal icon 41 and show the focal icon 41 as large as possible in the space. In this manner, the focal icon 41 (the item that has now been selected) is made more distinct, whereas other icons 41 are also recognizable. It will become easy for the user to shift the cursor 42 and the focus from the icon 41 to another icon.

It is also advisable to downscale the icons 41 other than the focal icon 41. FIG. 6(c) represents the main menu screen where the icons 41 adjacent to the focal icon 41 are downscaled. All icons other that the focal icon may be downscaled. In this way, the focal icon can be shown still larger.

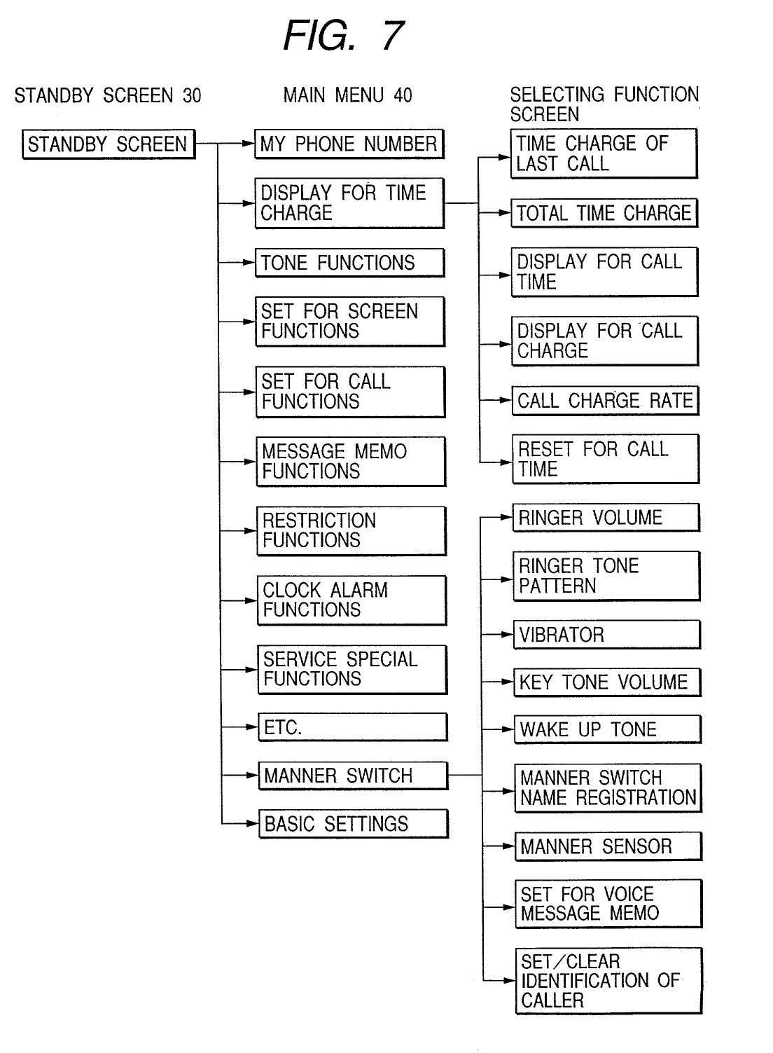

FIG. 7 lists examples of part of items from which to choose whose icons are shown on the main menu screen 40. The main menu screen 40 allows the user to choose from among a considerable number of items. FIG. 7 includes 12 items from which to choose on the assumption that 12 icons 41 corresponding to the items are shown on the main menu screen 40. If more items from which to choose are required, it is not desirable to show the icons corresponding to the items because additional operation may be required, that is, the user may scroll the screen to seek an icon to choose.

To enable the user to choose from among a greater number of items, in this preferred embodiment, for example, items from which to choose are grouped, according to conceptual resemblance, and one icon 41 is assigned to one group. In this case, the icon 41 contains the graphic symbols of the grouped items from which to choose. On the examples of the main menu screen 40, exemplified in FIGS. 6(a) and (b), for example, an icon 41 is shown, containing the displayed symbols “▪” and “∘” when the focus is not positioned on it. When the focus is positioned on it, the icon is animated. The state of the animated icon changes at certain intervals with the following rotating: the display of symbols “▪” and “∘”; the enlarged or detailed display of symbol “▪”; the enlarged or detailed display of symbol “∘”; and help indication display. At the same time, above the display area of the icons 41, in the space 43 for displaying item information, the title of the currently selectable item assigned to the focal icon 41, such as, for example, “DISPLAY FOR TIME CHARGE” is displayed. At this time, when the user pushes down the enter pushbutton of the joy stick 7, the selecting function screen of the selected item assigned to the focal icon 41 appears.

In this way, you can choose an item you desire to open without scrolling the main menu screen 40 and clearly know the specific title of the selectable item assigned to the icon on which the focus is currently positioned.

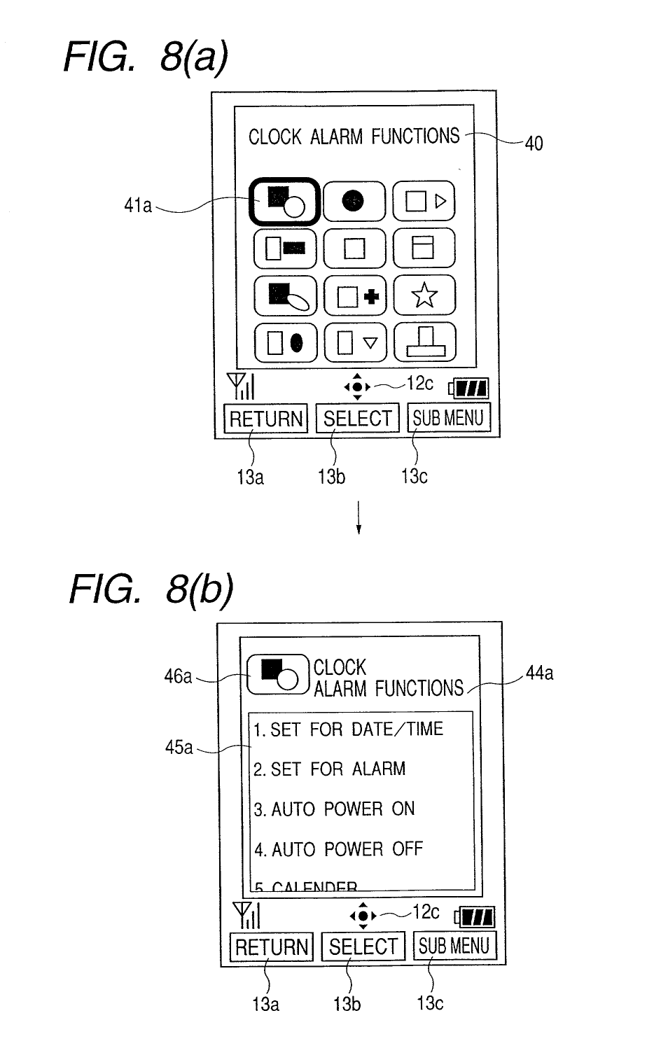

FIG. 8 shows a selecting function screen example chosen from the main menu screen 40.

FIG. 8(a) represents the main menu screen 40 where the focus is positioned on the icon (identified by reference numeral 41a) shown at the upper left corner and the title “CLOCK ALARM FUNCTIONS” assigned to the icon 41a is shown in the space 43 for displaying item information. At this time, by pushing down the enter pushbutton of the joy stick 7, the item “CLOCK ALARM FUNCTIONS” has now been chosen.

Then, a “CLOCK ALARM FUNCTIONS” selecting function screen 44a like the one shown in FIG. 8(b) appears on the display screen 1 (FIG. 1). The user can choose out of the items listed in the function item column 45a. In this example, five function items are listed: “SET FOR DATE/TIME”, “SET FOR ALARM”, “AUTO POWER ON”, “AUTO POWER OFF” and “CALENDAR”. When you choose one of these function items, a setting item confirming screen appears, allowing the user to confirm the setting of the chosen item, for example, function “SET FOR DATE/TIME”. By performing predetermined operation on this screen, a setting item changing screen further appears, allowing the user to change the setting.

At the foot of the selecting function screen 44a, the function display boxes 13a to 13b, the joy stick icon 12c, etc. are shown. Thus, if you press the left software key 3L to which the “return” function is assigned as indicated in the function display box 13a; you return to the main menu screen shown in FIG. 8(a).

Among the items listed in the function item column 45a, you can position the focus on any desired function item to choose by moving the cursor which is not shown. The cursor move is controlled by throwing the joy stick up or down. If there are remaining function items from which to choose which cannot be shown at the same time, the function item column 45a is scrolled up or down to show the remaining function items one by one after the cursor reaches the bottom or top edge of the function item column 45a. In this case, if more items still remains to be shown during a scroll up, an item that is the next to appear (“CALENDAR” in this example) is coming to appear halfway from the bottom edge, implying that more still remains to be shown. During a scroll down, an item that is the next to appear is coming to appear halfway from the top edge of the function item column 45a.

On the selecting function screen 44a, in a suitable position outside the function item column 45a, for example, at the upper left corner (title space), a mark 46a corresponding to the icon 41a of this screen 44a that has been chosen on the main menu screen 40 is also shown. Thus, it will be easily understandable that this screen 44a has been opened from the main menu screen 40 shown in FIG. 6 by choosing its icon. If, for example, you want to choose another selecting function screen from the main menu screen 40, you can get timing to return to the main menu screen 40 quickly. Screen switching is easier to perform.

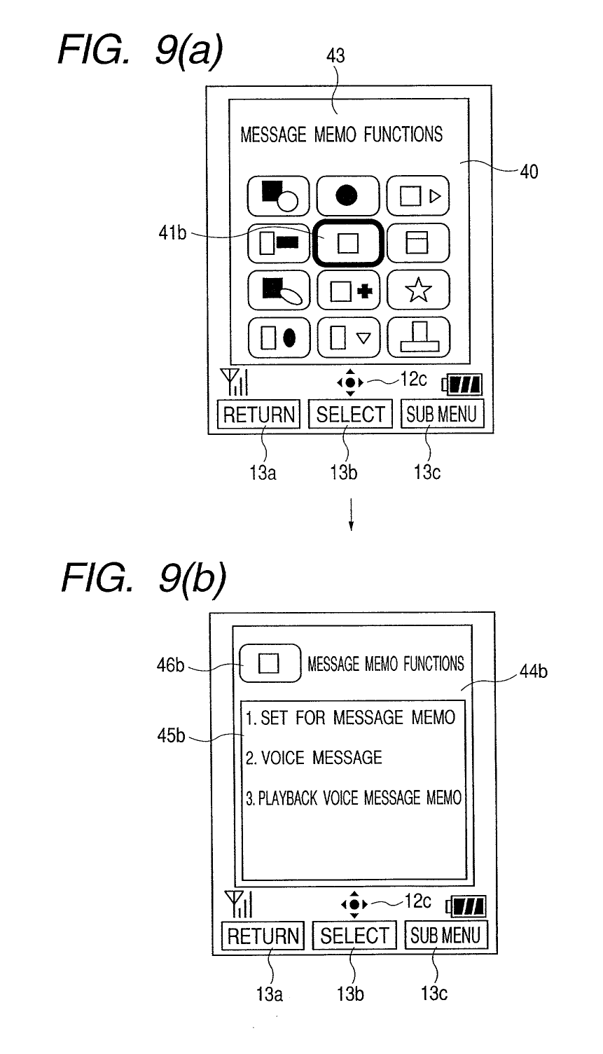

FIG. 9 shows another selecting function screen example which is opened from the main menu screen by selecting an icon (identified by reference numeral 41b) to which a single selectable item is assigned.

FIG. 9(a) represents the main menu screen where the focus is positioned on the icon 41b and the selectable item (represented by mark “□”) assigned to the icon 41b is assumed to be “MESSAGE MEMO FUNCTIONS” (FIG. 7). In this case, at the top of the main menu screen 40, a title name 43 of “MESSAGE MEMO FUNCTIONS” is displayed. In this case, the icon 41b is animated and its state changes at certain intervals with the following alternating: the display of the selectable item “□” and help indication display such as, for example, “Press key 0”.

FIG. 9(b) represents a “MESSAGE MEMO FUNCTIONS” selecting function screen 44b brought up by pushing down the enter pushbutton (fixing the selected icon) with the focus positioned on the icon 41b. The user can choose out of three function items “SET FOR MESSAGE MEMO”, “VOICE MESSAGE”, and “PLAYBACK VOICE MESSAGE MEMO” listed in the function item column 45b. When you choose one of these functions, the setting item confirming screen appears, allowing the user to confirm the setting of the chosen function, for example, function “SET FOR MESSAGE MEMO”. By performing predetermined operation on this screen, the setting item changing screen further appears, allowing the user to change the setting.

On this selecting function screen 44b, also, a mark 46b corresponding to the icon 41b is shown above the function item column 45b, as is the case for the “CLOCK ALARM FUNCTIONS” selecting function screen 44a shown in FIG. 8(b).

Even when you choose yet another icon 41 on the main menu screen 40, its selecting function screen appears in the same way as illustrated above.

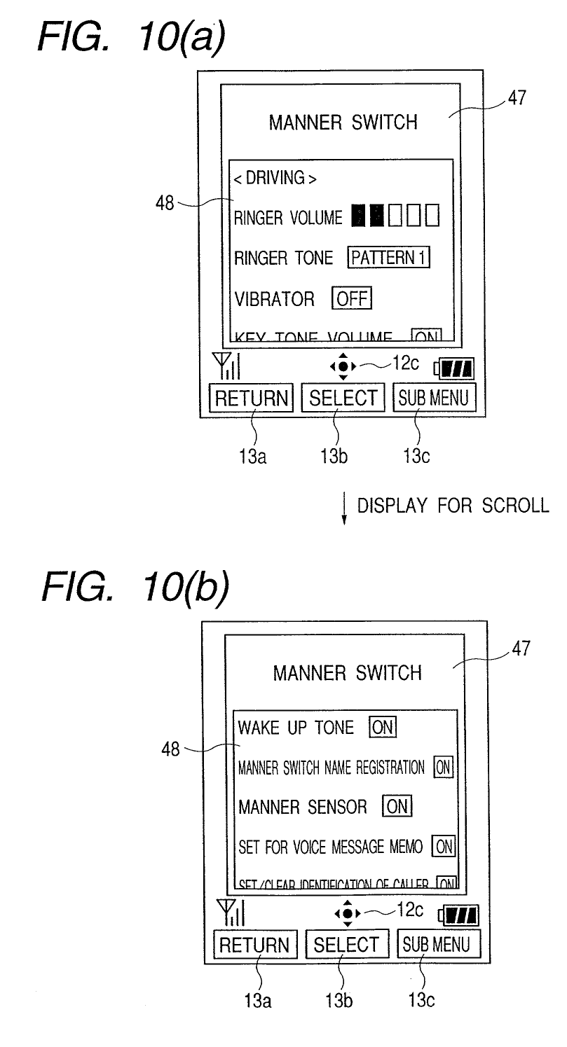

FIG. 10 shows examples of the setting item confirming screen 47 mentioned in FIG. 4.

FIG. 10(a) represents the setting item confirming screen 47 brought up by choosing the icon 41 of “MANNER SWITCH” on the main menu screen 40 shown in FIG. 6. In some cases, the setting item confirming screen 47 is directly opened from the main menu screen 40 as in this example.

On the setting item confirming screen 47, similarly, the function display boxes 13a to 13c, the joy stick icon 12c, etc. are shown at the foot of the screen.

The main part of the setting item confirming screen 47 is the setting item column 48 where the current settings for various matters of the pocket telephone are displayed so that the user can confirm the current settings. The setting items are, as shown in FIG. 7, “RINGER VOLUME”, “RINGER TONE PATTERN”, “VIBRATOR”, “KEY TONE VOLUME”, “WAKE UP TONE”, “MANNER SWITCH NAME REGISTRATION”, “MANNER SENSOR”, “SET FOR VOICE MESSAGE MEMO”, “SET/CLEAR IDENTIFICATION OF CALLER”, etc. According to the exemplary settings shown in FIG. 7, for example, “RINGER VOLUME” is set at a medium volume and pattern 1 of “RINGER TONE” is selected.

Because such many setting items cannot be shown simultaneously in the setting item column 48, the setting item column 48 with the setting items being displayed as exemplified in FIG. 10(a) is scrolled in the same manner of working the joy stick as described with FIG. 8. Then, the setting items that were invisible will appear as exemplified in FIG. 10(b). Also in this case, if more items still remains to be shown, an item that is the next to appear is coming to appear halfway from the bottom edge of the setting item column 48. Look at the bottom of the setting item column 48 shown in FIGS. 10(a) and (b).

When you choose one of the setting items listed in the setting item column 48 by positioning the cursor, which is not shown, on the item, the setting item changing screen, which is not shown, appears, allowing the user to change the setting of the chosen item.

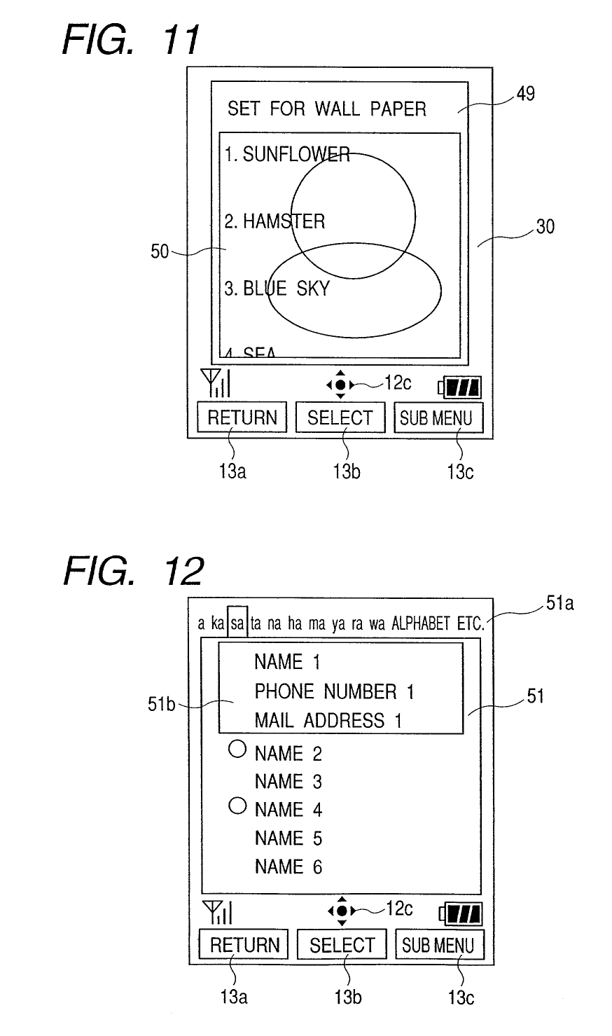

FIG. 11 shows an example of the setting item changing screen 49 mentioned in FIG. 4.

This example of the setting item changing screen 49 is used to change the wall paper on the standby screen 30 exemplified in FIG. 5. To bring up this screen, first choose the appropriate icon 41, for example, the icon of function “basic settings”, which is not identified, from the main menu 30 (FIG. 6). Then, the selecting function screen appears, listing function items from which you can choose, such as “RINGER TONE PATTERN”, “VIBRATOR”, “SET FOR STANDBY SCREEN”, etc. Select “SET FOR STANDBY SCREEN” on the selecting function screen, then the setting item conforming screen appears, listing the setting items such as “SET FOR WALL PAPER”, “SCREEN SAVER”, “SET FOR SAVING MODE”, “SET FOR CLOCK DISPLAY”, “SEASON ICON”, etc. From these items, select “SET FOR WALL PAPER”, then its setting item changing screen appears.

The “SET FOR WALL PAPER” setting item changing screen 40 is superposed on the standby screen 30 exemplified in FIG. 5 with wall paper patterns as setting items being listed in its setting item column 50. As is the case for the above-described screens, the function display boxes 13a to 13e, the joy stick icon 12c, etc. remain visible.

The setting items (wall paper patterns) listed in the setting item column 50 are, in this example, “SUNFLOWER”, “HAMSTER”, “BLUE SKY”, “SEA”, etc and their patterns which are made visible if selected. If these items cannot be shown simultaneously, the setting item column 50 is scrolled as described for the preceding screens. If more items still remains to be shown, an item that is the next to appear is coming to appear halfway from the bottom edge of the setting item column 50.

The standby screen 30 is visible through the setting item column 50. When you choose any desired wall paper pattern from the setting items to change the wall paper on the standby screen 30 to another one, the chosen wall paper replaces the existing one and will be visible through the column. Thus, you can change wall paper while actually confirming the change and wall paper exactly matching your taste can be easily set up.

To ensure that the user can change the wall paper on the standby screen 30 while directly confirming the change, there is sufficient spacing between the setting items shown in the setting item column. In view hereof, 50% or more of the area of the setting item column 50 is vacant space for making the wall paper visible.

[Address Book]

On the assumption that you choose an address book on the standby screen 30, the procedure of screen bring-up and related operation will be explained below.

When you press the left software key 3L (FIG. 1) with the standby screen 30 (FIG. 5) being displayed, an address book screen 51 which is exemplified in FIG. 12 appears. The address book screen 51 is also superposed on the standby screen 30 with the function display boxes 13a to 13c, the joy stick icon 12c, etc remaining visible at the foot of the screen.

On the address book screen 51, the names of parties or persons whom the user of the pocket telephone of the invention has contacted or may contact are listed in the order of the Japanese syllabary. You can choose one of these name entries by working the joy stick (FIG. 1) and positioning the focus on it. The focus is positioned by default on one of the entries on the address book screen 51. For the focal entry, a larger display area (hereinafter, referred to as a detail information display area) 51b than for other entries is set and detailed information for the person or party of the entry is displayed in this area. Now, assume that the focus is positioned on the first entry in the list (name 1) and its detailed information is shown. To change the focal entry, throw the joy stick 7 (FIG. 1) up or down. When you shift the focus to the second entry of name 2 from the display state shown in FIG. 12, the detail information display area 51b for displaying the detailed information for the name 2 appears with the name being shown at the top of this area 51b as is name 1 in FIG. 12.

The number of entries of parties or persons whom the user of the pocket telephone of the invention has contacted or may contact (the number of entries to be displayed) is constant if there are many entries and the number of parties or persons to be displayed on the address book screen remains unchanged even if the detailed information for a person or party is displayed.

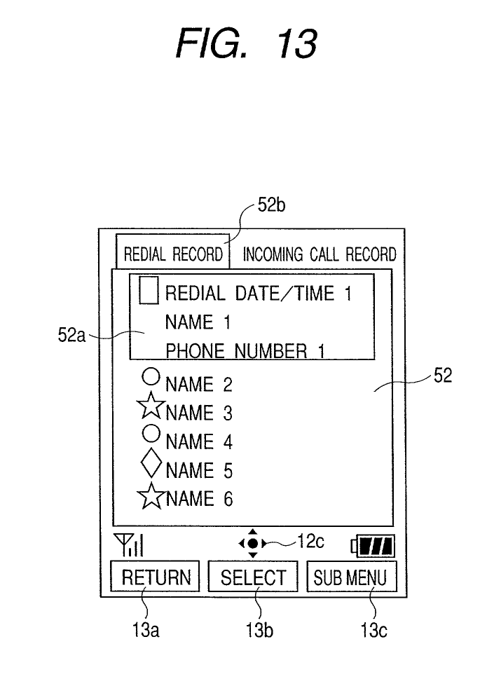

If there are many entries, to display more entries that still remains to be shown on the address book screen 51, scroll the screen 51 up or down. Scrolling should be performed as follows. Position the focus on the bottom name entry (name 6 in the example shown in FIG. 13) by throwing the joy stick 7 up or down and make the detail information display area 51b shown there. In this state, you can scroll the address book screen 51 up by further throwing the joy stick 7 down. Conversely, for a scroll-down, position the focus on the top name entry and make the detail information display area 51b shown there. In this state, you can scroll the address book screen 51 down by further throwing the joy stick 7 up.

At the top of the address book screen 51, a selecting area 51a is provided where the kana letters of vowel “A” (A, Ka, Sa, . . . ) in the Japanese syllabary, “ALPHABET”, and “ETC.” are shown. By selecting one of the kana letters of vowel “A” in the Japanese syllabary in the selecting area 51a, the entries of person or party names whose initial letter is any of a series of the kanas of the same consonant starting with the selected letter are displayed in the order of the vowels A, I, U, E, O. In the example case shown in FIG. 12, “Sa” is selected and the entries of person or party names are displayed in the order of Sa, Si, Su, Se, So. If you select “ALPHABET”, the entries of person or party names are displayed in alphabetical order. If you select “ETC”, the entries are arranged in order other than the above systems. Selection can be made by throwing the joy stick 7 (FIG. 1) to the left or the right.

The detailed information to be displayed in the detail information display area 51b is retrieved from the memory 24 (FIG. 3) of the pocket telephone. In the address book memory provided within the memory 24, the following information for each party or person whom the user of the pocket telephone of the invention has contacted or may contact is stored: the name of the party or person, telephone number, type of telephone, E-mail address, group, ringer tone pattern, ringer volume, vibrator pattern, LED light color, backup light, wall paper, incoming rejection, secret, remarks, registration number, date/time of creation (mail, call, etc.), update date/time, last contact date/time, the number of times of contacts, etc. Among them, predetermined information such as, for example, name, telephone number, E-mail address, contact date/time, last contact date/time, the number of times of contacts, etc. is displayed as detailed information in the detail information display area 51b.

The above-mentioned type of telephone may be a specific pocket telephone model supplied by a pocket telephone company, wired telephone, fax, etc. This information identifies the pocket telephone model or other communications equipment used by the person or party whom the user of the pocket telephone of the invention has contacted or may contact, related carrier information (such as the limited number of characters per mail, mail compatibility, and displayable file formats) and other matters. If such information is supplied and stored in the memory of the pocket telephone, it is feasible that communication such as sending mail is automatically performed in a suitable mode for the pocket telephone model or other communications equipment used by the person or party whom the user of the pocket telephone of the invention has contacted or may contact. For example, if a limit is placed on the number of characters to be mailed by the pocket telephone used by a person or party whom the user of the pocket telephone of the invention has contacted or may contact, automatic alerting is feasible to inform you that the limit is exceeded when you enter characters to create mail to be sent to that person or party. If you enter mail text in a file format that is incompatible with the mail file format of the pocket telephone used by the person or party of destination of the mail, automatic alerting is also feasible to inform you that mail communication is impossible.

Other information besides the pocket telephone model or other communications equipment used by a person or party whom the user of the pocket telephone of the invention has contacted or may contact, related carrier information, etc. may be displayed as detailed information in the detail information display area 51b.

The above-mentioned update date/time is the data/time at which the information contents for a person or party whom the user of the pocket telephone of the invention has contacted or may contact, such as the pocket telephone model, was updated. The last contact date/time and the number of time of contacts relate to the record of the contacts with the person or party by mail or call. The incoming rejection means that the pocket telephone is set not to receive calls or mail from the person or party to which this information is attached.

Each time the pocket telephone receives a call or mail from a person or party whom the user of the pocket telephone of the invention has contacted or may contact in the list, the controller 13 (FIG. 3) checks such information as telephone number, telephone type, and Email address mentioned above. Specifically, the controller 13 checks the received information against the corresponding information stored in the memory (FIG. 3) for the name of the caller or the mail sender. If, for example, its E-mail address changes, the controller updates the corresponding information stored and reregisters the date/time of the update into the memory 24. The controller also updates the date/time of last contact and increments the number of contacts by one.

In the memory 24, the carrier information (the limited number of characters per mail, mail compatibility, displayable file formats) is stored for each telephone type registered. When you send mail to a person or party, the controller 13 identifies the telephone type used by the person or party by referring to the information from the memory 24, makes sure of the carrier information for the telephone type, and presents predetermined information as described above to the user.

Among the entries of person or party names displayed on the address book screen 51, those that fulfill the following conditions are marked with a specific mark (for example, a circle “∘”) indicating that you have contacted the parson or party at a relatively high frequency. The conditions are, but not limited to:

the number of times you have contacted the person or party exceeding a preset threshold;

top N persons or parties with regard to the number of times of contacts;

total time for which you contacted the person or party exceeding a preset threshold;

top M persons or parties with regard to the total contact time;

a total count of characters of mail text for the person or party exceeding a preset threshold; and

top n persons or parties with regard to the total count of characters of mail text.

The name entry of a person or party whom the user of the pocket telephone of the invention has contacted or may contact that fulfills at least one of the above conditions is marked. The user can arbitrarily set the above threshold and values N, M, and n.

Such detailed information as described above is read from the address book memory and displayed in the detail information display area 51b and the foregoing variety of detailed information can be displayed by scrolling this area 51b. For example, this scrolling is performed by pushing down the enter pushbutton of the joy stick (FIG. 1) and throwing the joy stick up or down. Push down the enter pushbutton again, then you will exit this scrolling mode and you can shift the focus to another entry on the address book screen 51b.

[Redial/Incoming Call Record]

On the assumption that you choose redial/incoming call record on the standby screen 30, the procedure of screen bring-up and related operation will be explained below.

When you throw the joy stick 7 (FIG. 1) to the left with the standby screen 30 (FIG. 5) being displayed, a redial/incoming call record screen 52 which is exemplified in FIG. 13 appears. The redial/incoming call record screen 52 is also superposed on the standby screen 30 with the function display boxes 13a to 13c, the joy stick icon 12c, etc remaining visible at the foot of the screen.

At the top of the redial/incoming call record screen 52, items from which to choose “REDIAL RECORD” and “INCOMING CALL RECORD” are displayed. By choosing either by positioning the cursor 52b on it (you can choose either “REDIAL RECORD” or “INCOMING CALL RECORD” by throwing the joy stick 7 (FIG. 1) to the left or the right), the names of persons or parties whom the user of the pocket telephone of the invention has contacted in the chosen record are displayed in a list on the redial/incoming call record screen 52. In the example shown in FIG. 13, the “REDIAL RECORD” has been chosen and on the redial/incoming call record screen 52, the names of persons or parties whom the user of the pocket telephone of the invention has contacted are displayed in a list sequentially from the latest contact; i.e., name 1, name 2, . . . and so on, with the name 1 being the one whom the user of the pocket telephone of the invention has contacted most lately.

On the redial/incoming call record screen 52, you can choose one of these name entries by working the joy stick 7(FIG. 1) and positioning the focus on it. The focus is positioned by default on one of the entries on the redial/incoming call record screen 52. For the focal entry, a larger display area (hereinafter, referred to as a record information display area) 52a than for other entries is set and record information (the above-mentioned items of information stored in the address book memory, such as telephone number, update date/time, last contact date/time, the number of times of contacts, etc.) for the person or party of the entry is displayed in this area. Now, assume that the focus is positioned on the first entry in the list (name 1) and its record information is displayed as “REDIAL DATE/TIME (last contact date/time)”, “Name 1”, “PHONE NUMBER”, etc.

To change the focal entry, throw the joy stick 7 (FIG. 1) up or down. When you shift the focus to the second entry of name 2 from the display state shown in FIG. 13, the record information display area 52a for displaying the record information for the name 2 appears with the name being shown at the top of this area 52a as is name 1 in FIG. 13. Other matters about the redial/incoming call record screen are the same as for the address book screen 51 shown in FIG. 12.

To each name entry displayed on the redial/incoming call record screen 52, an icon indicating the type of contact means is attached. To a person or party whom you contacted by telephony of the pocket telephone, the icon of mark “∘” is attached. To a person or party whom you contacted by E-mail, the icon of mark “☆” is attached. To a person or party whom you contacted by C-mail, the icon of mark “⋄” is attached. To a person or party whom you contacted by a plurality of types of contact means, the respective marks of the types are attached. Therefore, if the focus is positioned on, for example, the entry of name 3 whom you contacted with mark “☆” attached thereto, the record (redial record in this example, as indicated by the position of the cursor 52b) of contacts by Email with the name 3 is displayed in the record information display area 52a.

Such record display enables the user to know what person or party he or she contacted by what means. This is true for a case where you have chosen incoming record by using the cursor. In this case, you can know what person or party contacted you by what means.

[Mail Menu]

On the assumption that you choose a mail menu on the standby screen 30, the procedure of screen bring-up and related operation will be explained below.

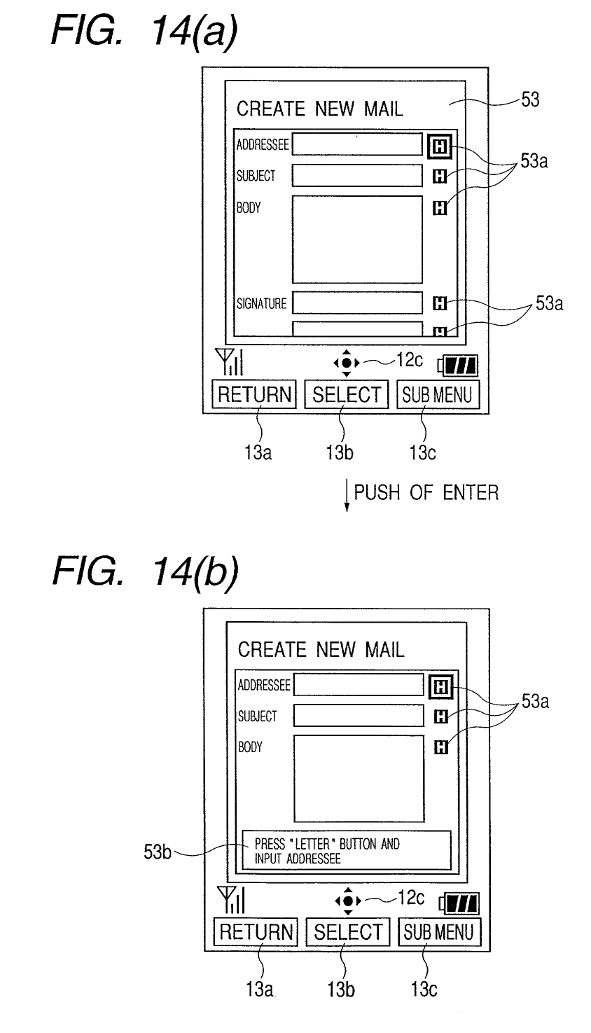

When you press the mail key 6 (FIG. 1) with the standby screen 30 (FIG. 5 being displayed, the mail menu screen (not shown) appears on the display screen 1 (FIG. 1) which allows the user to choose send or receive. On this screen, when you choose send by working the joy stick 7, a create new mail screen 53 which is exemplified in FIG. 14(a) appears. The create new mail screen 53 is also superposed on the standby screen 30 with the function display boxes 13a to 13c, the joy stick icon 12c, etc remaining visible at the foot of the screen.

On the create new mail screen 53, there are “ADDRESSEE”, “SUBJECT”, “BODY”, “SIGNATURE” and other input fields. With the focus being positioned on one of the “ADDRESSEE”, “SUBJECT”, “BODY”, “SIGNATURE” and other input fields, when you throw the joy stick 7 to the right, you can position the focus on the help icon at the right of the field. Using the character input keys 11, enter the address, subject, text, and signature into these fields and press the mail key 6 again, then you can send the mail. The focal help icon may be shown with its color changed or it may be framed or enlarged so that you can identify it readily.

Among the help icons for the “ADDRESSEE”, “SUBJECT”, “BODY”, “SIGNATURE” and other input fields, you can shift the focus from one to another by throwing the joy stick 7 up or down. By pushing down the enter pushbutton, you can choose to fix the focal help icon 53a. The focal help icon 53a is shown larger than other help icons.

FIG. 14(b) represents the create new mail screen where the help icon 53a of “ADDRESSEE” input field has been chosen in the display state shown in FIG. 14(a) and a display area 53b appears where help information is displayed. This display area 53b can be removed by pushing down the enter pushbutton again.

Owing to the respective help icons 53a for the input fields provided on this screen, calling help for each input will be performed by simple operation and help information you need for filling an input field can be obtained without confusion with another field.

When the “ADDRESSEE”, “SUBJECT”, “BODY”, “SIGNATURE” and other input fields are empty on the create new mail screen 53 exemplified in FIGS. 14(a) and (b), “RETURN” is shown in the function display box 13a and the above-mentioned “return” function is assigned to the left software key 3L (FIG. 1, FIG. 2). Once at least one character has been entered in any of the above fields, as described above, the “clear” function that clears a character entered is assigned to the left software key 3L (FIG. 1, FIG. 2) with “CLEAR” being shown in the function display box 13a.

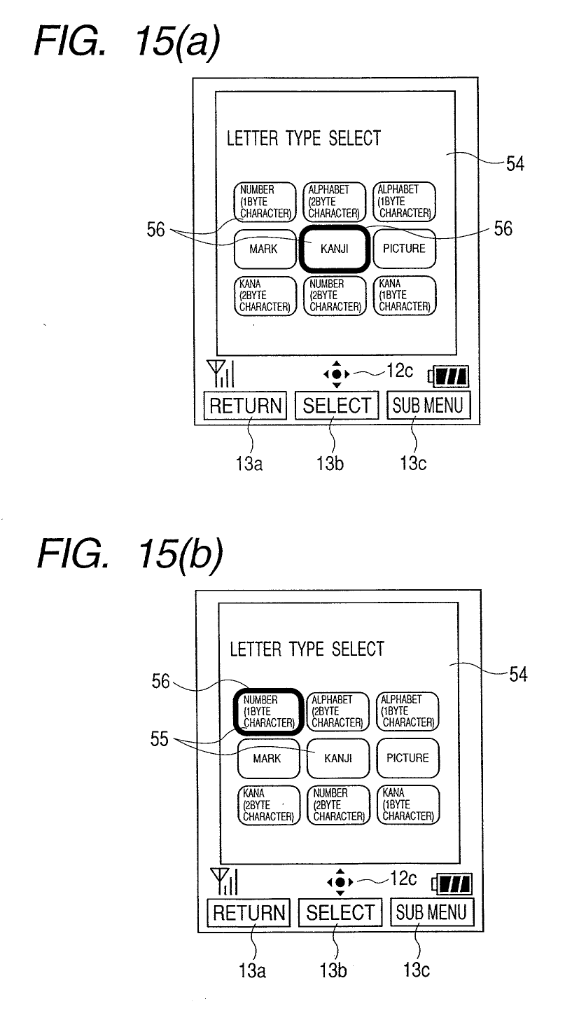

With the create new mail screen 53 being displayed as exemplified in FIG. 14, when you press the right software key 3R (FIG. 1) to which the “submenu” function is assigned as indicated in the function display box 13, a submenu appears. When you choose “letter type” from the submenu, a letter type select screen 54 which is exemplified in FIG. 15 appears. This screen allows the user to choose a letter type to be used for entering mail text and related matters on the create new mail screen 53. On the screen exemplified in FIG. 15, you can choose out of nine letter types: “number” (1-byte character), “alphabet” (2-byte character), “alphabet” (1-byte character), “mark”, “kanji”, “picture”, “kana” (2-byte character), “number” (2-byte character), and “kana” (1-byte character).

A letter type 55 to choose is surrounded by a frame-like cursor 56 and the focus is positioned on it. The cursor 56 can be shifted by throwing the joy stick 7 up, down, to the left, or to the right and you can shift the focus to any desired letter type 55. Choosing to fix the focal letter type 55 is performed by pushing down the enter pushbutton of the joy stick 7.

When inputting alphabets, kana letters, and numbers, using the character input keys 11 shown in FIG. 2, letter type selection can be made, according how many times you pressed a key. Notwithstanding, the letter type select screen 54 enables selection from nine letter types by simple operation without pressing a key many times and rapid letter type selection can be performed.

FIGS. 15(a) and (b) represent the initial state of the letter type select screen 54 with the initial focus (default focus) position being set on one of the nine options. In the case of the letter type select screen 54 shown in FIG. 15(a), the focus (default focus) is positioned on the letter type (“kanji”) 55 in the center of the letter type options arrayed in three columns by three rows such that the focus will be shifted to another letter type 55 over a relatively short distance. Thus, the number of times you have to throw the joy stick 7 can be decreased. In the case of the letter type select screen 54 shown in FIG. 15(b), the focus is positioned on the letter type 55 at the upper left corner. Alternatively, the default focus may be set to be positioned on a letter type 55 that is most frequently used.

[Tab Menu]

As an option substituting for the main menu screen 40 which was explained with FIG. 6, a tab menu can be set up. If such an optional main menu has been set up, when you push down the enter pushbutton of the joy stick 7 with the standby screen 30 exemplified in FIG. 5 being displayed, the optional main menu screen appears. This optional main menu screen will be explained below as another example of the main menu screen.

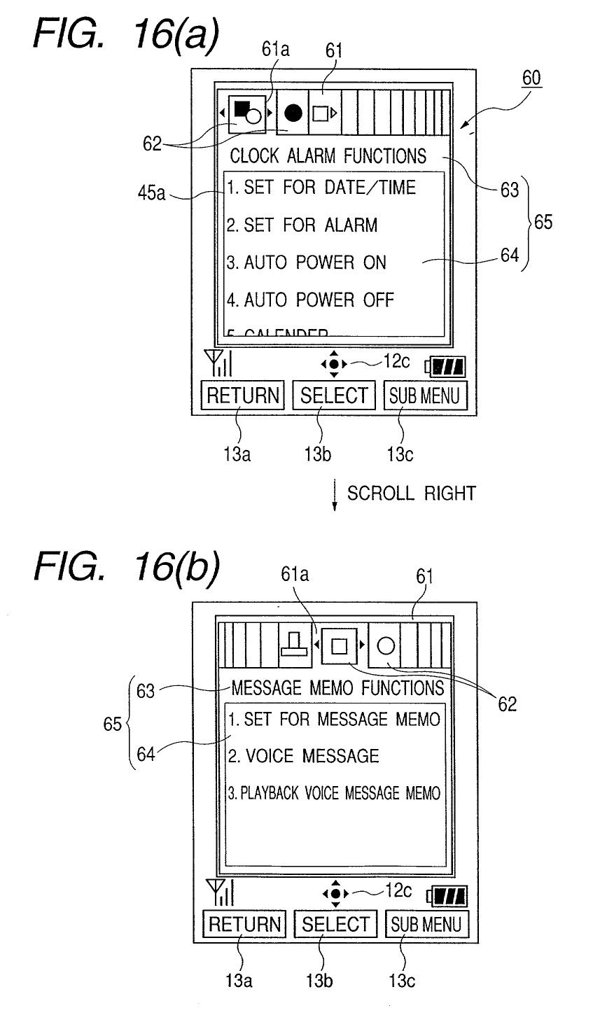

FIG. 16 shows examples of the optional main menu screen.

At the top of the main menu screen 60 exemplified in FIG. 16(a), there is a selectable items display zone 61 where the icons 62 of items from which to choose are lined horizontally. A window 61a is formed as a part of the selectable items display zone 61 and one icon 62 always exists in the window 61a. The icon 62 existing in the window 61a corresponds to the focal icon 41 on the main menu window 40 exemplified in FIG. 6. Icons 62 other than the icon 62 existing in the window 61a are shown in line lying one on top of another with the overlap being greater and greater toward the other end from the icon 62 in the window 61a. Thus, for the unselected icons 62 nearer to the icon 62 in the window 61a, the more part thereof is visible.

On the main menu screen 60, a function item column 64 is provided and a selecting function screen 65 appears like the one exemplified in FIG. 8 for the icon 62 of the selected item in the window 61a of the selectable items display zone 61. This selecting function screen 65 consists of the item display area 63 where the title of the screen is shown and the function item column 64 where the function items from which to choose are shown in a list.

The window 61a of the selectable items display zone 61 is shifted to the right or the left in the selectable items display zone 61 as you throw the joy stick 7 to the right or the left. Thereby, the icon 62 to fall in the window 61a can be replaced, or in other words, the focal icon 62 can be replaced. FIG. 16(b) represents the main menu screen where another icon has been chosen by shifting the window 61a in the way described above, then the icon 62 of “MESSAGE MEMO FUNCTIONS” has fallen in the window 61a, that is, the focal icon has changed to this icon 62. If only the “MESSAGE MEMO FUNCTIONS” item being selected is assigned to the icon 62, “MESSAGE MEMO FUNCTIONS” only will be shown in the item display area 63 with the focus being positioned on the icon. In the function item column 64, the function items from which to choose for the “MESSAGE MEMO FUNCTIONS” item being selected are displayed in a list as shown in FIG. 16(b).

In this example, both the main menu screen and the selecting function screen 65 chosen from the main menu are displayed simultaneously on the display screen 1 (FIG. 1) in the manner described above.

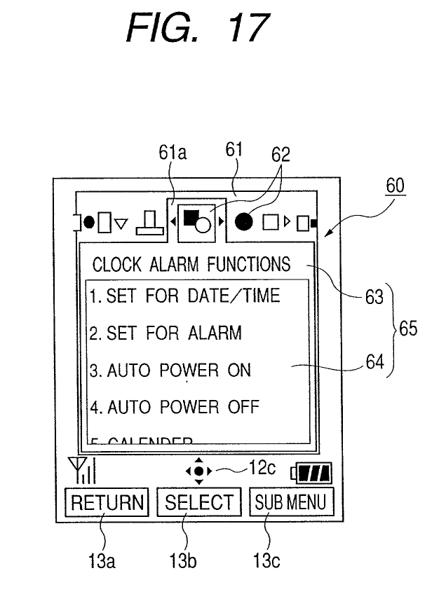

FIG. 17 shows yet another example of the optional main menu screen.

The main menu screen shown in FIG. 17 has the selectable items display zone 61 with the window 61a and the item display area 61 and when the icon 61 in the window 61a is fixed, the function item column 64 listing the function items relevant to the icon is displayed. In this respect, the screen shown in FIG. 17 is the same as the main menu screen 60 exemplified in FIG. 16 and its components corresponding to those in FIG. 16 are identified by the same reference numerals. In the screen example shown in FIG. 17, the window 61a is fixed in the middle of the selectable items display zone 61. As you throw the joy stick 7 to the left or the right, the icons 62 in line shifts to the left or the right so that the focal icon 62 can be replaced.

In this example, the icons 62 in the selectable items display zone 61 are of equal size and shown in evenly spaced positions. Consequently, icons 62 far from the icon 62 in the window 61a are invisible outside the screen. Like the screen examples shown in FIG. 16, it is also possible to make all icons visible by lining them such that they lie one on top of another with their overlap being greater and greater towards either end from the icon 62 in the window 61a.

The screen example modified in this way is also the same as the screen examples shown in FIG. 16 except that focal icon 62 is shown in the middle of the icons in line and produces the same effect as does the examples shown in FIG. 16.

If a predetermined time has elapsed as the screen remains displayed without change of its contents by user operation, the screen automatically changes to a partial display screen 70 (FIG. 4) so that the battery power consumption will decrease.

As explained above, according to the present invention, the alphabets corresponding to the vowels in Japanese in the Romaji input mode are assigned to the character keys in a specific column in the key arrangement. This makes it easy for the user to enter characters in Romaji mode by smoother operation.

In accordance with the present invention, the main menu screen chosen from the standby screen is displayed superposed on the standby screen so that the standby screen will be visible through the main menu screen. On a selecting function screen chosen from the main menu, its icon chosen on the main menu screen is shown. Thus, the preceding screen can readily be recognized. Even if the screen is displayed long, what screen from which the present screen has been opened is readily understandable and this makes it easy for the user to proceed next operation.

Moreover, according to the present invention, the icons other than the focal icon on the main menu screen shift or shift with their size being downscaled so that the display area for the focus icon can be enlarged. Thus, the focal icon can easily be identified while the number of icons to be shown on the main menu screen can be maintained, and selection from other icons is made easily.

Furthermore, according to the present invention, a list of persons or parties whom the user of the pocket telephone of the invention has contacted or may contact is displayed on the address book screen and the focus is always positioned on one of the entries with its detailed information about the address book being displayed. No matter what entry is selected as the focal one, the entries to be displayed remain unchanged. You can easily shift the focus among the entries and obtain the detailed information for any entry as you desire to know.

Moreover, according to the present invention, on the record screen listing a plurality of name entries of persons or parties whom the user of the pocket telephone of the invention has contacted, an icon to indicate the type of contact means taken at the last contact is attached to each entry. The focus is always positioned on one of the entries and its record information such as last contact date/time, the number of times of contacts, etc. is displayed. The type of contact means for each person or party whom the user of the pocket telephone of the invention has contacted can easily be known and you can easily shift the focus among the entries and obtain the detailed record for any entry as you desire to know.

Furthermore, according to the present invention, on the create new mail screen comprising a plurality of input fields, a help icon is assigned to each field. Thus, you can obtain help information for each input field and make efficient use of help information.

Moreover, according to the present invention, the functional information about the pocket telephone model or other communications equipment used by a person or party whom the user of the pocket telephone of the invention has contacted or may contact, such as the maximum number of characters displayable, displayable file formats, etc is stored in memory. When you enter mail text, using the create new mail screen, you can refer to this functional information so that you can send mail in a format suitable for the model or other communications equipment used by the person or party to which you are going to send the mail.

Furthermore, according to the present invention, both the main menu screen and the selecting function screen chosen from the main menu can be displayed simultaneously. Thus, you can choose another selecting function screen and directly switch over to it from the currently displayed selecting function screen, that is, the present invention makes it easier or smoother for the user to bring up the desired screen.

What is claimed is:

1. A pocket telephone including an operation surface on which function keys and character input keys arrayed in three columns by four rows are provided, said character input keys comprising:
three columns of keys, one of which consisting of four character input keys to which four out of five alphabet letters corresponding to the vowels in Japanese are assigned to be used to enter Japanese characters in Romaji input mode, the remaining one of the five alphabet letters being assigned to a function key just above the top character input key in the same column, wherein the keys of the five alphabet letters are arranged in the order of the vowels according to the Japanese syllabary.

2. A pocket telephone arranged such that a standby screen is displayed when its power is turned on and a predetermined screen is opened by actuating a function key on the operation surface, wherein:
the predetermined screen is superposed on the standby screen so that the standby screen will be visible through the predetermined screen.

3. The pocket telephone as recited in claim 2, wherein:
said predetermined screen is a main menu screen where a plurality of icons are shown, arranged in an array, corresponding to items or groups of items from which to choose, said icons being rearranged such that:
when one of the icons is chosen and a focus is positioned on it, it is shown enlarged and the remaining icons other than the focal icon shift, thus providing space for widening the area where the focal icon is shown.

4. The pocket telephone as recited in claim 2, wherein:
said predetermined screen is a main menu screen where a plurality of icons are shown, arranged in an array, corresponding to items or groups of items from which to choose, said icons being rearranged such that:
when one of the icons is chosen and the focus is positioned on it, it is shown enlarged and the remaining icons other than the focal icon shift with their size being downscaled, thus providing space for widening the area where the focal icon is shown.

5. The pocket telephone as recited in claim 3, wherein:
a selecting function screen is opened by choosing one of the icons of the items or groups of items from which to choose displayed on said main menu screen, and on the selecting function screen, the chosen icon as well as particular items under the thus chosen item are displayed.

6. The pocket telephone as recited in claim 4, wherein:
a selecting function screen is opened by choosing one of the icons of the items or groups of items from which to choose displayed on said main menu screen, and on the selecting function screen, the chosen icon as well as particular items under the thus chosen item are displayed.

7. The pocket telephone as recited in claim 2, wherein:
said predetermined screen is an address book screen where a plurality of name entries of persons or parties whom the user of said pocket telephone has contacted or may contact are displayed in a list with the focus positioning on one of the entries, for the focal entry, its detailed information about the address book as well as the name of the person or party being displayed.

8. The pocket telephone as recited in claim 2, wherein:
said predetermined screen is a record screen where a plurality of name entries of persons or parties whom the user of said pocket telephone has contacted are displayed in a list, an icon to indicate the type of contact means taken at the last contact being attached to each name entry and the focus positioned on one of the entries, for the focal entry, its record information such as last contact date/time, the number of times of contacts, etc. as well as the name of the person or party being displayed.

9. The pocket telephone as recited in claim 2, wherein:
said predetermined screen is a create mail screen comprising a plurality of input fields, where a help icon is assigned to each of the input fields so that the user of said pocket telephone can obtain help information for each input field.

10. The pocket telephone as recited in claim 9, wherein:
for the persons or parties whom the user of said pocket telephone has contacted or may contact, functional information about their pocket telephone model or other communications equipment, such as the maximum number of characters displayable, displayable file formats, etc. is stored in memory so that the user can refer to the functional information when entering mail text at said create main screen.

11. The pocket telephone as recited in claim 9, wherein:
when said create new mail screen is displayed, by actuating a specific key on said operation surface and choosing from a submenu, a letter type select screen is opened where a plurality of icons of letter type options are laid out, on one of which the focus is always positioned.

12. The pocket telephone as recited in claim 10, wherein:
when said create new mail screen is displayed, by actuating a predetermined key on said operation surface and choosing from a submenu, a letter type select screen is opened where a plurality of icons of letter type options are laid out, on one of which the focus is always positioned.

13. The pocket telephone as recited in claim 2, wherein:
said predetermined screen is a main menu screen where a plurality of icons are shown, arranged in a single row, corresponding to items or groups of items from which to choose, with one of the plurality of icons being selected by default and the focus being positioned on it, wherein the user of said pocket telephone can choose any desired icon by shifting the focus; and
by choosing to fix the focal icon, a selecting function screen is opened where particular items under the item of the chosen icon are displayed in a list with the icons in the row remaining visible.
